(19) United States
(12) Patent Application Publication
(10) Pub. No.: US 2026/0179797 A1
(43) Pub. Date: Jun. 25, 2026

(54) RADIATION SHIELD AND ASSOCIATED SYSTEMS AND METHODS

(71) Applicant: RAMPART IC, Inc., Birmingham, AL (US)

(72) Inventors: Robert E. Foster, Vestavia Hills, AL (US); William Thomas Livingston, Madison, MS (US); J. Dylan Quick, Birmingham, AL (US); Matthew B. Lemay, Hingham, MA (US)

(21) Appl. No.: 19/432,856

(22) Filed: Dec. 24, 2025

Related U.S. Application Data
(60) Provisional application No. 63/738,666, filed on Dec. 24, 2024.

(51) Int. Cl. G21F 3/00

(52) U.S. Cl. CPC G21F 3/00

(57) ABSTRACT

A radiation attenuating shield apparatus and associated systems, devices, and methods are disclosed herein. In some embodiments, a radiation attenuating shield apparatus includes a first radiation shield panel and a second radiation shield panel, both of which are composed of a material that at least partially blocks radiation. The radiation attenuating shield apparatus is configurable between (i) a collapsed configuration in which the second panel substantially overlaps with the first panel to define a first radiation blocking footprint, and (ii) an expanded configuration in which less of the second panel overlaps with the first panel to define a second radiation blocking footprint that is greater than the first radiation blocking footprint.

### CROSS-REFERENCE TO RELATED APPLICATION(S)

The present application claims the benefit of U.S. Provisional Ser. No. 63/738,666, filed Dec. 24, 2024, the disclosure of which is incorporated herein by reference in its entirety.

### BACKGROUND

The present disclosure relates generally to radiation protection devices, and specifically to radiation attenuating devices to protect medical personnel from radiation emitted in the operating room.

Recent improvements in electronics and robotics have enabled surgeons to use noninvasive microsurgical techniques to replace numerous open incision techniques. When the site of surgical intervention is not open to the operating room, the site must still be visualized in order to adequately guide and control the instruments. This can be accomplished by radiographic monitoring, the most common example of which is X-ray monitoring. During the procedure, an X-ray generator is positioned proximate the patient to emit X-rays to the surgical site (this is generally below the patient, although the position of the X-ray generator can be varied as necessary). An X-ray intensifier is positioned to receive the emitted X-rays after they have passed through the surgical site, to convey image data to a monitor or other means to present a visual image to the surgeon.

Although these microsurgical techniques represent a vast improvement over previous open body techniques in terms of trauma to the patient, recovery time, and risk of infection, the constant radiographic monitoring exposes everyone involved to more radiation than was required using the old techniques. This is a minor concern for the patient, who is likely to undergo only a small number of such surgeries in a lifetime. However, the professional medical staff who perform these procedures have much more frequent exposure, and the cumulative exposure over years or decades of work can exceed safe limits unless the staff are protected.

Previous attempts to solve these problems have limitations. Placing heavy shielding around the patient can block the radiation from reaching the medical staff. However, the medical staff still need access to the patient's body, so complete shielding is impractical; because the human body is transparent to X-rays (“radiolucent”), X-rays can pass through the patient's body and expose the medical staff. Any surgery carries with it a risk of life-threatening complications that would require the medical staff to have immediate access to the patient's body. Heavy shields around the patient's body can also be bulky and difficult to move, which can prevent emergency access by the medical staff to the patient in such a situation.

Another attempt to protect medical staff during such procedures has involved worn shielding, or basically radiation “armor.” These have taken the form of lead vests, lead skirts, lead thyroid collars, leaded acrylic face shields, leaded acrylic glasses, and “zero gravity” leaded suits. Radiation armor has a serious disadvantage: it must be of significant mass to block X-rays (generally containing lead, a very dense metal), and it is heavy to wear. Wearing heavy radiation armor rapidly fatigues even a physically fit wearer, and with chronic use can cause orthopedic disorders. When using radiation armor to protect medical staff from X-rays, one health hazard is simply being exchanged for another. Glasses and face shields by themselves might be of a manageable weight, but alone they protect only a tiny portion of the body.

“Zero gravity” suits are leaded body suits that are suspended by a rigid metal frame. The frame is mounted on some supporting structure, such as the floor or ceiling. As a result the wearer does not support the suit with his or her body. This type of suspended armor has additional drawbacks. It leaves the wearer's hands and lower arms uncovered and unprotected to allow the wearer to engage in fine manual work. It limits the wearer's range of bodily movement to movements that can be accommodated by the frame, often preventing the wearer from bending over or sitting. They use a static face shield that prevents the wearer from bringing anything close to the face, for example for visual scrutiny. Suspended armor systems are also extremely expensive due to their complexity and due to material costs, currently costing about $70,000 per suit.

Another form of radiation armor is the mobile “cabin,” that is a radiation attenuating box on wheels in which the user stands. The user is able to push the cabin from place to place while inside. The cabin has arm ports at a certain height and a visually transparent portion at a certain height. As a result the user's hands and face cannot be repositioned or reoriented much, for example to stand or lean over. It also uses a static face shield that prevents the wearer from bringing anything close to the face, for example for visual scrutiny.

Dual-pane hinged radiation shields, such as the Rampart M1128 (Rampart IC, LLC, Birmingham, Alabama), were significant improvements over the art. Using two jointed shields supported by a mobile boom, they were capable of casting a radiation “shadow” across a portion of the operating room large enough to obviate the need for personal protective equipment in the space where the shadow was located. They were also readily repositioned as necessary in the room and among rooms. However, it would be advantageous to maximize the space in the radiation shadow/radiation blocking footprint, while retaining the advantages of the M1128.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments shown, but are provided for explanation and understanding.

FIG. 1 is a front perspective view of a radiation attenuating shield apparatus configured in accordance with various embodiments of the present technology.

FIG. 2 is a rear perspective view of the radiation attenuating shield apparatus of FIG. 1.

FIG. 3 is a top view of the radiation attenuating shield apparatus of FIG. 1.

FIG. 4 is a top view of a radiation attenuating shield structure of the radiation attenuating shield apparatus of FIG. 1.

FIG. 5 is an enlarged rear perspective view of a joint between two shield shields of the radiation attenuating shield apparatus of FIG. 1, configured in accordance with various embodiments of the present technology.

FIG. 6 is an enlarged front perspective view of the joint of FIG. 5.

FIG. 7 is a partially exploded, perspective view of another radiation attenuating shield structure configured in accordance with embodiments of the present technology.

FIG. 8 is a perspective view of another radiation attenuating shield structure configured in accordance with embodiments of the present technology.

FIG. 9 is a perspective view of another radiation attenuating shield apparatus configured in accordance with various embodiments of the present technology.

FIG. 10A is a rear perspective view of another radiation attenuating shield structure configured in accordance with various embodiments of the present technology.

FIG. 10B is an enlarged, partially exploded view of a portion of the radiation attenuating shield structure of FIG. 10A.

FIGS. 10C and 10D are rear perspective views of the radiation attenuating shield structure of FIG. 10A in various configurations.

FIG. 11 is a partially schematic view of a medical imaging system configured in accordance with various embodiments of the present technology.

### DETAILED DESCRIPTION

The present technology is generally directed to radiation attenuating shield structures that are configurable between expanded, collapsed, and/or other configurations. Existing shield structures are commonly made of leaded acrylic glass or other materials that attenuate radiation yet are visually transparent or translucent. This allows users, such as physicians, to operate on patients with an adequate field of view while remaining protected from radiation from imaging equipment. However, many existing shield structures are bulky, heavy, static (and thus difficult to adapt to specific patient or operating needs), etc. Also, existing shield structures may not provide a complete or otherwise adequate radiation shadow or radiation blocking footprint to fully protect users.

Embodiments of the present technology address at least some of the above described shortcomings. For example, embodiments of the present technology include a radiation attenuating shield structure with at least two radiation shield panels movably coupled to one another. For example, a first radiation shield panel can rotate or slide relative to a second radiation shield panel such that a user can configure the radiation attenuating shield structure between (i) a collapsed configuration in which the two radiation shield panels substantially overlap, allowing easy storage, and (ii) an expanded configuration in which the second radiation shield panel extends outward from the first radiation shield panel, thus maximizing the size of the radiation shadow/radiation blocking footprint to provide more protection. The radiation attenuating shield structure can also be configured in any number of intermediate configurations to adapt to patient and/or operating needs. In some embodiments, when the radiation attenuating shield structure is in the expanded configuration, the two radiation shield panels partially overlap with one another to avoid forming any gaps in the radiation shadow (e.g., between the two panels).

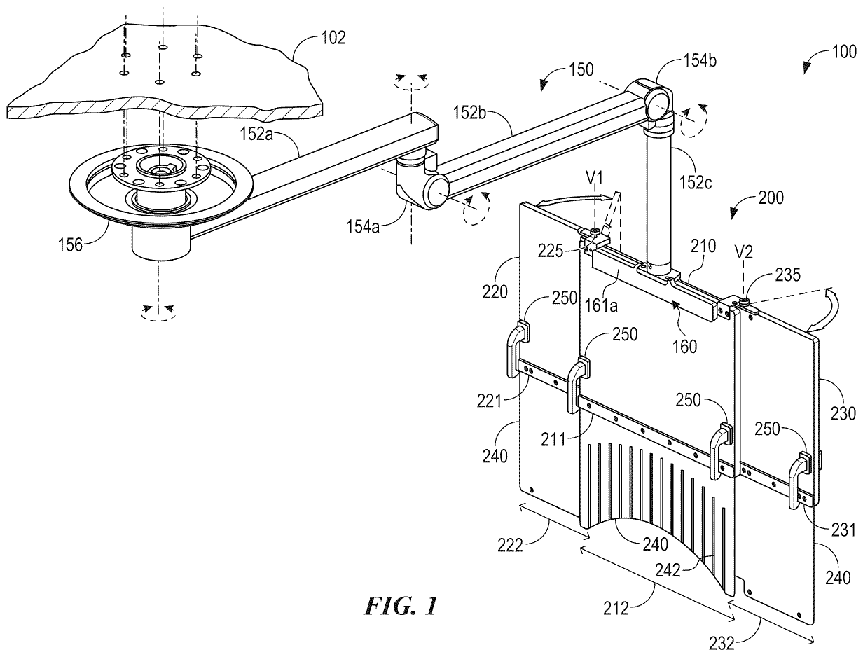

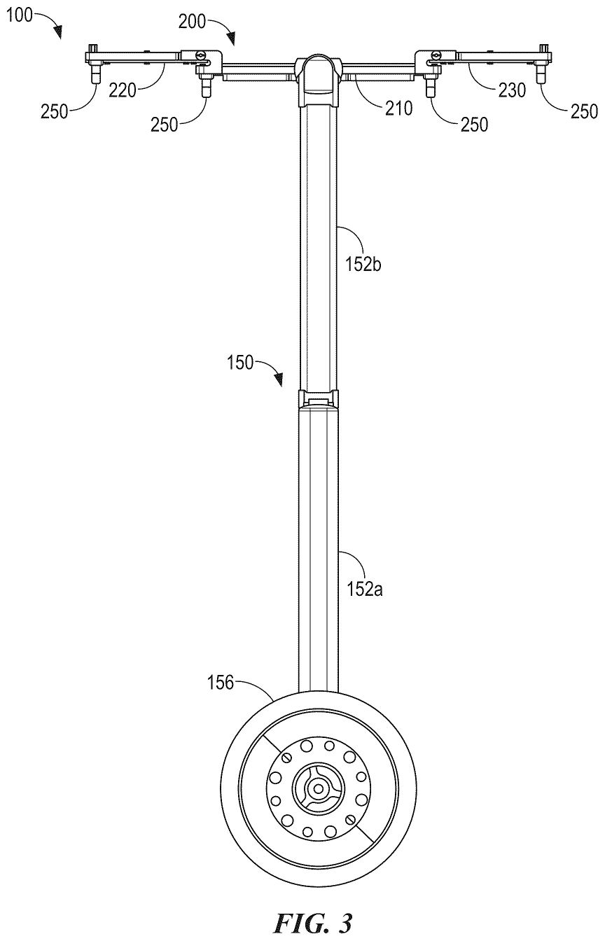

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc. The terminology used in the description presented below is intended to be interpreted in its broadest reasonable manner, even though it is being used in conjunction with a detailed description of certain specific embodiments of the present technology. Certain terms may even be emphasized below; however, any terminology intended to be interpreted in any restricted manner will be overtly and specifically defined as such in this Detailed Description section. Additionally, the present technology can include other embodiments that are within the scope of the examples or claims but are not described in detail with respect to FIGS. 1-11.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

The “subject” or “patient” refers to a human or animal upon which a medical intervention is performed while on a table. The description below refers to human subjects, but it is specifically contemplated that the same methods and apparatuses disclosed herein could be effectively employed when the subject is a non-human animal.

The headings provided herein are for convenience only and are not to be used to interpret the scope of the claimed technology.

### Representative Embodiments of Radiation Attenuating Shield Apparatuses

FIGS. 1, 2, and 3 are front perspective, rear perspective, and top views, respectively, of a radiation attenuating shield apparatus 100 (“the apparatus 100”) configured in accordance with various embodiments of the present technology. The apparatus 100 can be used above a table (not shown) for supporting a subject (also not shown). Referring to FIGS. 1-3 together, the apparatus 100 comprises a radiation attenuating shield structure 200 supported by a support arm 150. The radiation attenuating shield structure 200 comprises three panels or shields that each are designed to at least partially attenuate or otherwise block radiation: a first or central shield panel 210 (“the central shield panel 210”), a second or left shield panel 220 (“the left shield panel 220”), and a third or right shield panel 230 (“the right shield panel 230”) (collectively referred to as “the shield panels 210, 220, 230”). The left shield panel 220 is connected to the central shield panel 210 via a first hinge or joint 225 and is configured to rotate relative to the central shield panel 210 along a first approximately vertical axis V1 defined at least partially by the first joint 225. Similarly, the right shield panel 230 is connected to the central shield panel 210 via a second joint 235 and configured to rotate relative to the central shield panel 210 along a second approximately vertical axis V2 at least partially defined by the second joint 235.

The central shield panel 210, the left shield panel 220, and the right shield panel 230 can be shaped to facilitate their mutual rotation and creation of an adequate radiation shadow. In the illustrated embodiment, the shield panels 210, 220, 230 comprise quadrilateral (e.g., rectangular) shields and thus have at least two parallel sides. Advantageously, the parallel right and left sides simplify the design of parallel vertical axes for the joints between them. In other embodiments, one or more of the central shield panel 210, the left shield panel 220, and the right shield panel 230 can have non-quadrilateral shapes (e.g., pentagonal, hexagonal, irregular, etc.)

The shield panels 210, 220, 230 can be dimensioned to provide adequate radiation protection to the user. For example, the central shield panel 210, the left shield panel 220, and the right shield panel 230 may be independently designed to have a height sufficient to provide protection to the upper body of a user standing near the table when the apparatus 100 is in use. Any or all of the central shield panel 210, the left shield panel 220, and the right shield panel 230 may have a height sufficient to extend up to about head-level of an average user standing on the floor and/or from a level close to the table. In some embodiments, the height of each of the central shield panel 210, the left shield panel 220, and the right shield panel 230 can be between 20-100 cm, 28-84 cm, 32-80 cm, 36-76 cm, 40-72 cm, 44-68 cm, 48-64 cm, or 52-60 cm, or any specific value therein, such as about 56 cm.

The central shield panel 210 can have a first width 212 that is about the same as a width of the patient table (not shown). For example, the central shield panel 210 can have a first width 212 that is between 30-100 cm, such as about 60 cm. The left shield panel 220 and the right shield panel 230 can have a second width 222 and a third width 232, respectively, that is between 20-200% of the first width 212. For example, each of the second width 222 and the third width 232 can be between 6-200 cm, such as about 30 cm. In some embodiments, the second width 222 and the third width 232 are each about half of the first width 212. Such relative widths can help provide a large radiation shadow/radiation blocking footprint and enable reconfiguration of the radiation attenuating shield structure 200 and reshaping of the radiation shadow/radiation blocking footprint.

In the illustrated embodiment, the radiation attenuating shield structure 200 is in an expanded configuration in which the central shield panel 210, the left shield panel 220, and the right shield panel 230 lie on substantially parallel planes. For example, the central shield panel 210 extends within a first plane, and the left shield panel 220 and the right shield panel 230 extend within a second plane. In some embodiments, the first plane and the second plane are parallel but different (e.g., the second plane is partially offset from the first plane). As described in greater detail below, placing the central shield panel 210 in a different plane than the left shield panel 220 and the right shield panel 230 advantageously enables the left shield panel 220 and the right shield panel 230 to at least partially overlap the central shield panel 210, even when in the expanded configuration. This is expected to reduce the amount of radiation that leaks between adjacent shield panels 210, 220, 230.

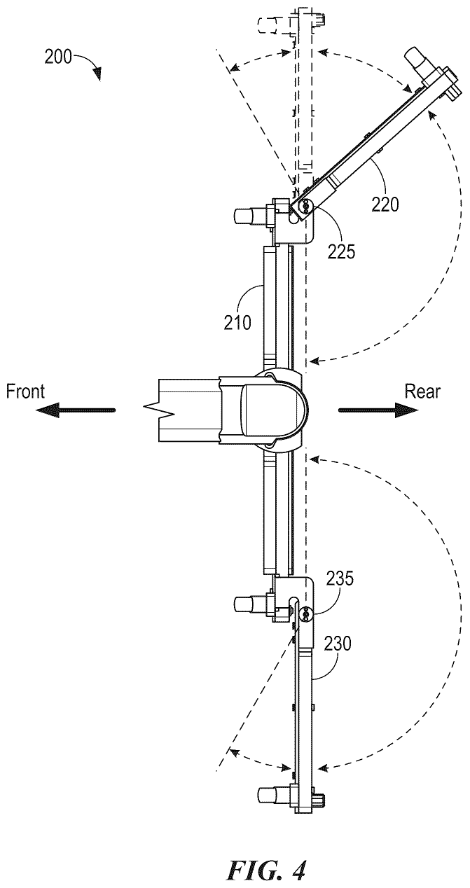

When the radiation attenuating shield structure 200 is in the expanded configuration, as shown, a portion of each of the left shield panel 220 and the right shield panel 230 can overlap with portions of the central shield panel 210. As discussed in further detail herein, such overlap can advantageously reduce the likelihood of radiation leaking between adjacent shield panels, thereby also reducing the likelihood of there being gaps in the radiation shadow/radiation blocking footprint. The central shield panel 210, the left shield panel 220, and the right shield panel 230 are discussed in greater detail below with reference to FIGS. 4-6.

One or more flexible shields or curtains 240 may be connected to a first bottom edge 211 of the central shield panel 210, a second bottom edge 221 of the left shield panel 220, and/or a third bottom edge 231 of the right shield panel 230. The one or more flexible shields 240 can conform to the contour of the patient and/or table, and advantageously close potential gaps between the bottom edges of the shield panels 210, 220, and 230, and the table or patient (not shown). In the illustrated embodiment, the flexible shield 240 coupled to the first bottom edge 211 of the central shield panel 210 includes slits 242 that divide the flexible shield 240 into multiple strips, allowing the flexible shield 240 to easily conform to various contours. The flexible shields 240 can also be composed of a radiation attenuating material. However, rather than being rigid and transparent like the shield panels 210, 220, and 230, the flexible shields 240 can be composed of a flexible, non-rigid, and non-optically transparent material.

The one or more flexible shields 240 may extend from the bottom edges 211, 221, 231 of the central shield panel 210, left shield panel 220, and right shield panel 230. The one or more flexible shields 240 may be sized to extend far enough from the shield panels 210, 220, 230 in a downward direction to bridge an expected gap between the bottom edges 211, 221, 231 of the shield panels 210, 220, 230 and the subject and/or the table. For example, the flexible shields 240 may extend downwardly from the bottom edges 211, 221, 231 by a distance of at least 5 cm, at least 10 cm, at least 15 cm, at least 20 cm, at least 25 cm, at least 30 cm, at least 35 cm, at least 40 cm, at least 45 cm, at least 50 cm, at least 55 cm, at least 60 cm, or at least 65 cm. In some embodiments, the flexible shields 240 extend downwardly from the bottom edges 211, 221, 231 by a distance of between 5 -65 cm, 32-62 cm, 34-60 cm, 36-58 cm, 38-56 cm, 40-54 cm, 42-52 cm, 44-50 cm, or 46-48 cm, such as about 47 cm.

In some embodiments, the bottom edges 211, 221, 231 of the central shield panel 210, the left shield panel 220, and the right shield panel 230, respectively, can be approximately or exactly flush with one another (e.g., positioned at about the same height). In some embodiments, only one of the bottom edge 221 of the left shield panel 220 or the bottom edge 231 of the right shield panel 230 is flush with the bottom edge 211 of the central shield panel 210. Having flush bottom edges, in conjunction with the flexible shields 240 hanging therefrom, is expected to allow the shield panels 210, 220, 230 to be positioned over any portion of the patient's body and at any orientation, while reducing the likelihood of any significant gaps in shielding between the patient's body and the radiation attenuating shield structure 200.

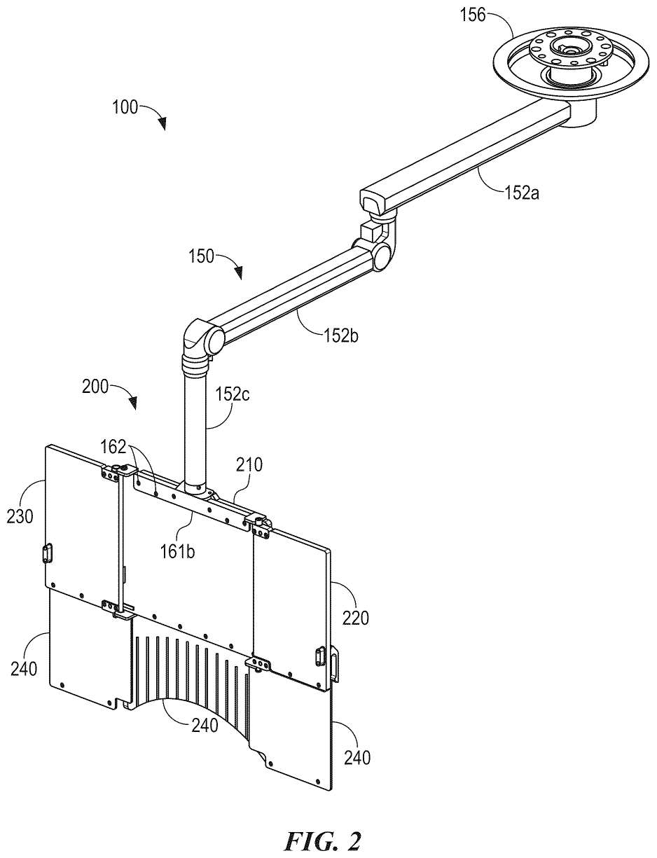

The support arm 150 can be connected to a top edge (e.g., at a center point thereof) of the central shield panel 210 and configured to support (e.g., lift, suspend) the radiation attenuating shield structure 200 from a ceiling 102. For example, in the illustrated embodiment, the support arm 150 is coupled to the top edge of the central shield 210 via a mounting bracket 160. As shown in FIGS. 1 and 2, the bracket 160 can have two elongate support panels 161a and 161b extending along a generally horizontal axis, with the central shield panel 210 positioned therebetween. Screws, bolts, or other fastening mechanisms 162 (FIG. 2) can extend between the two support panels 161a and 161b and through the central shield panel 210. In some embodiments, the support panels 161a and 161b extend between about 60-90% of the first width 212 of the central shield panel 210 to improve stability. Additionally or alternatively, the support arm 150 may be coupled to the radiation attenuating shield structure 200 at other, singular, or multiple, connection points.

In the illustrated embodiment, the support arm 150 is an elongate structure including one or more arm segments or booms (individually labeled 152a-152c, collectively referred to as “the arm segments 152”), one or more hinges (individually labeled 154a, 154b, collectively referred to as “the hinges 154”), and a ceiling mount 156. The ceiling mount 156 can be mounted to the ceiling 102 via fasteners (e.g., bolts) and/or other mounting mechanism. The arm segments 152 can extend away from the ceiling mount 156 with the hinges 154 coupled between individual arm segments 152 to allow rotations thereof. The arm segment 152a can also rotate relative to the ceiling mount 156. The arm segment 152c may extend along a vertical axis between the hinge 154b and the central shield panel 210, and may also be referred to as an overhead boom. The support arm 150 can be constructed of any material of sufficient mechanical strength to support the radiation attenuating shield structure 200, such as steel. In some embodiments, the support arm 150 is constructed from a radiation attenuating material. For example, the support arm 150 can attenuate X-rays at energies typical of radiology applications.

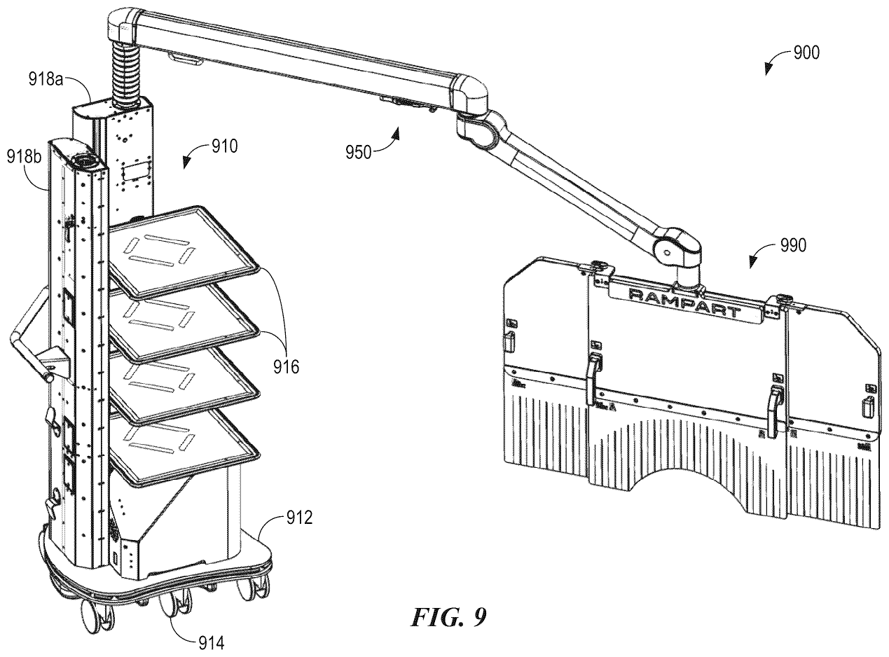

While the support arm 150 is ceiling-mounted in the illustrated embodiment, in other embodiments, the support arm 150 can be supported from a floor, a wall, or another structure. For example, the support arm 150 can be integrally mounted on the floor, or alternatively supported by a floor-stand, either mobile or static. Such a floor-stand may include wheels to allow easy movement of the apparatus 100 (e.g., into, within, and out of an operating room), and an example is illustrated in and described below with reference to FIG. 9. The floor-stand may alternatively be supported by a static base. The base may be of sufficient width and weight distribution to stably support the apparatus 100 when it is moved to a range of different positions. Also, the support arm 150 may be supported from overhead, from the side, or from below. For example, the floor-stand may support the apparatus 100 either from above (in a crane-type configuration), from the side, or from below. Alternatively, the apparatus 100 may be supported by a ceiling mount (as illustrated) or a wall mount, which can advantageously free up floor space in the operating room.

In operation, the support arm 150 can translate and rotate the radiation attenuating shield structure 200 within the operating room relative to the table. For example, the support arm 150 can allow manual translation of the radiation attenuating shield structure 200 and/or mechanical translation of the radiation attenuating shield structure 200 via one or more actuators. In particular, one or more handles 250 can be attached to at least one of the central shield panel 210, the left shield panel 220, or the right shield panel 230. A user (e.g., a physician, an imaging technician, etc.) can use the handles 250 to reposition and/or reorient the radiation attenuating shield structure 200. As discussed further herein, the user can also use the handles 250 to rotate the left shield panel 220 and/or the right shield panel 230 relative to the central shield panel 210.

Accordingly, the support arm 150 can position the radiation attenuating shield structure 200 at a level at or above a table surface supporting a subject. The support arm 150 can also position at least one of the central shield panel 210, the left shield panel 220, or the right shield panel 230 away from the table and thus above, for example, the floor. Thus, the support arm 150 can advantageously support all or some of the shield panels 210, 220, 230 above a patient's body during a procedure. Also, the support arm 150 can position any or all of the of the central shield panel 210, the left shield panel 220, and the right shield panel 230 at a height adequate to protect the user. For example, the support arm 150 can position the top edges of any or all of the central shield panel 210, the left shield panel 220, and the right shield panel 230 up to about at least head-level of an average human user, such as between 100-200 cm or between 165-184 cm (e.g., about 172 cm) from the floor. In some embodiments, the heights of the central shield panel 210, the left shield panel 220, and the right shield panel 230 can be set to be different from one another.

In some embodiments, the central shield panel 210 can rotate relative to the support arm 150, allowing the shield panels 210, 220, 230 to be oriented in a variety of ways relative to the subject and the table without necessarily moving the support arm 150. For example, the central shield panel 210 can rotate relative to the support arm 150 about a longitudinal axis of the arm segment 152c (e.g., a vertical axis or an axis slightly offset from the vertical). This rotation can allow the shield panels 210, 220, 230 to be aligned along a longitudinal side of the table, along a lateral side of the table, over the subject bisecting the body along a sagittal plane, a transverse plane, or another plane that is orthogonal to the frontal plane. Such bisection can create large radiation shadows/radiation blocking footprints without being limited to placement along an edge of the table or away from the table. In some embodiments, all three of the central shield panel 210, the left shield panel 220, and the right shield panel 230 can rotate as a singular unit relative to the support arm 150.

FIG. 4 is a top view of the radiation attenuating shield structure 200. As shown, the left shield panel 220 and the right shield panel 230 can rotate relative to the central shield panel 210 at varying degrees about the first joint 225 and the second joint 235, respectively. In some embodiments, at least one of the left shield panel 220 or the right shield panel 230 can rotate relative to the central shield panel 210 by at least 20°, 45°, 90°, 135°, 180°, or 210°. In the illustrated embodiment, each of the left shield panel 220 and the right shield panel 230 is illustrated as capable of rotating by about 30° towards the front and rotating by a full 180° towards the rear. Accordingly, the radiation attenuating shield structure 200 can be stowed away in a collapsed configuration having a smaller profile than the expanded configuration (e.g., illustrated in FIGS. 1-3) by rotating (e.g., folding) each of the left shield panel 220 and the right shield panel 230 by a full 180° towards the rear. In the collapsed configuration, the left shield panel 220 and the right shield panel 230 substantially overlap with the central shield panel 210, when viewed from the front or the rear. For example, in the collapsed configuration, at least 75%, at least 80%, at least 85%, at least 90%, at least 95%, or 100% of the area of the left shield panel 220 and the right shield panel 230 can overlap with the central shield panel 210.

Moreover, the central shield panel 210, the left shield panel 220, and the right shield panel 230 can be rotated relative to one another to assume multiple configurations (e.g., at 10° towards the front, at 70° towards the rear). For example, the shield panels 210, 220, 230 can be folded to form sides of a rectangle or a trapezoid, thereby blocking radiation from reaching users from the right of the subject, the left of the subject, and/or the superior and/or inferior sides of the subject simultaneously when the central shield panel 210 is positioned over the subject transversely. Thus a large radiation shadow/radiation blocking footprint can be created during a procedure, especially when X-ray imaging is only needed at an upper (superior) region or lower (inferior) region of the subject's body.

In another example, in the expanded configuration the radiation attenuating shield structure 200 can be positioned over the subject to bisect the subject's body along a midline of the subject such that a radiation shadow is created on the right or left side of the subject. The radiation attenuating shield structure 200 can also be positioned differently, such as transversely across the subject or at an angle across the subject.

The central shield panel 210, the left shield panel 220, and the right shield panel 230 can each be composed of a material that at least partially attenuates (e.g., blocks) radiation from passing therethrough. For example, in one embodiment the central shield panel 210, the left shield panel 220, and the right shield panel 230 are composed of an acrylic material impregnated with a heavy metal. In some embodiments, the material can include a non-toxic heavy metal such as bismuth. Such materials are described in U.S. Pat. No. 10,026,513, the disclosure of which is incorporated by reference herein in its entirety. In other embodiments, other materials can be used, including lead acrylic.

The thickness of the shield panels 210, 220, and 230 is generally proportional to the radiopacity of the shield panels 210, 220, and 230. Thus, in designing the shield panels 210, 220, 230, a balance can be struck between achieving adequate radiopacity and limiting the weight of the apparatus 100. For example, in some embodiments, each of the shield panels 210, 220, 230 can be made of lead that is about 0.5-1.5 mm thick or about 0.8-1.0 mm thick. Less dense materials, such as lead or bismuth acrylic, may need to be thicker to achieve the same level of radiopacity as lead. For example, each of the shield panels 210, 220, 230 can be made of bismuth or lead acrylic that is about 12-35 mm thick or about 18-22 mm thick. In another example, each of the shield panels 210, 220, 230 can be made of lead barium type glass that is about 7 -17 mm thick (e.g., about 7, 9, 14, or 17 mm thick). Comparing these representative materials, lead has the advantage of better radiopacity per unit thickness, while acrylic has the advantage of visual transparency. In some embodiments, at least one of the central shield panel 210, the left shield panel 220, or the right shield panel 230 is transparent to visible light. In such embodiments, the transparent shield panel(s) may have an optical transmissivity that equals or exceeds one of 50%, 55%, 60%, 65%, 70%, 75%, 80%, 85%, 90%, 95%, 99%, and 100%.

The radiopacity of the shield panels 210, 220, 230 can be expressed as millimeter-lead equivalents. In some embodiments, at least one of the shield panels 210, 220, 230 has a radiopacity of least 0.5 mm, 1.0 mm, 1.5 mm, 2 mm, 3 mm, or 3.3 mm lead equivalent. The radiopacity of the shield panels 210, 220, 230 can also be designed to provide a certain level of protection given the expected levels of radiation to be used. Together, the central shield panel 210, the left shield panel 220, and the right shield panel 230 can form a radiation attenuating barrier, blocking a significant amount of radiation from passing through. In some embodiments, the central shield panel 210, the left shield panel 220, and the right shield panel 230 can together block substantially all radiation in a certain range of wavelengths (e.g., X-rays) from passing through.

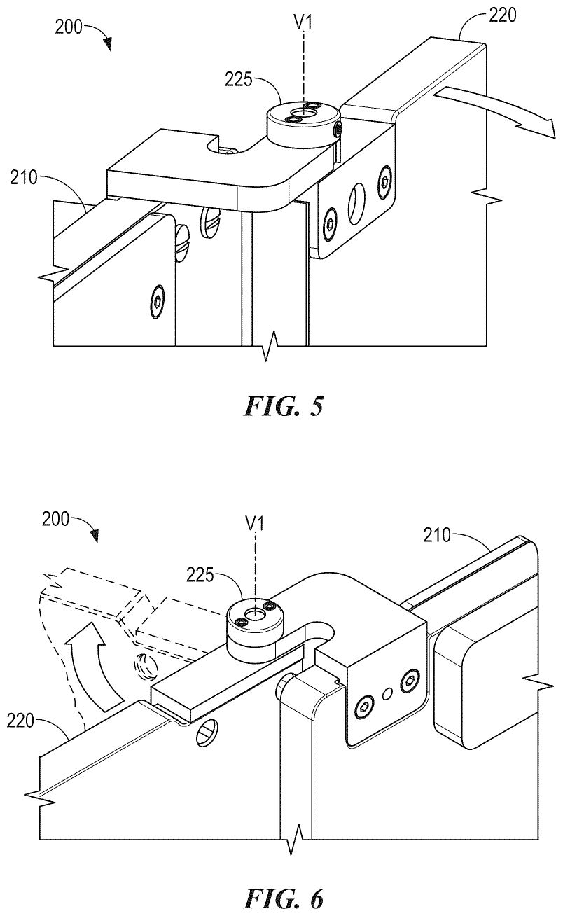

FIGS. 5 and 6 are enlarged rear perspective and front perspective views, respectively, of the first joint 225 between the central shield panel 210 and the left shield panel 220. Unless indicated otherwise, discussion of the first joint 225 herein applies equally to the second joint 235 coupled between the central shield panel 210 and the right shield panel 230. Further, although only one first joint 225 is shown, the illustrated first joint 225 can be an “upper” first joint 225 and the structure 200 can further include a “lower” first joint that hingedly couples the central shield panel 210 and the left shield panel 220 proximate lower edges of the central shield panel 210 and the left shield panel 220.

Referring to FIGS. 5 and 6 together, the first joint 225 can be coupled to top portions or edges of each of the central shield panel 210 and the left shield panel 220, and can allow rotation of the left shield panel 220 relative to the central shield panel 210 about the first vertical axis V1. In some embodiments, the first joint 225 is a radiopaque joint (e.g., radiopaque brace or lap joint) that can thus further reduce the transmission of radiation. Alternatively, the first joint 225 may simply have a sufficiently small air gap through which very little radiation can pass through.

The radiation attenuating shield structure 200 can be designed to reduce the likelihood of radiation leaking between adjacent shield panels 210, 220, 230. For example, when the radiation attenuating shield structure 200 is in the expanded configuration in which the central shield panel 210 and the left shield panel 220 lie on parallel or substantially parallel (but different) planes, a first side edge region of the central shield panel 210 and a second side edge region of the left shield panel 220 can at least partially overlap, when viewed from the front or rear. The overlap can be between about 1 cm and about 10 cm, or between about 2 cm and 8 cm, or about 2 cm, about 3 cm, about 4 cm, about 5 cm, or about 6 cm. This configuration is expected to provide a substantially complete radiation shadow by avoiding forming gaps visible from the front or rear. However, to maximize the radiation blocking footprint in the expanded configuration, less than about 20% of the total area of the left shield panel 220 overlaps with the central shield panel 210 when in the expanded configuration (when viewed from the front or the rear). For example, the overlapping region can be between about 1%-10%, or between about 1%-5% of the total area of the left shield panel 220. Alternatively, another substantially complete radiation shadow can be accomplished by joining the shields with a sufficiently narrow gap therebetween.

By virtue of having overlapping panels, in some embodiments, the left shield panel 220 can be rotatably coupled to the central shield panel 210 via the first joint 225 without an elongate vertical member serving as a hinge therebetween. In other words, the radiation attenuating shield structure 200 of the illustrated embodiment does not require a vertical rod, bar, or hinge that extends along the heights of the central shield panel 210 and the left shield panel 220. Such a vertical member may be composed of metal (e.g., steel) which may exhibit poorer radiation attenuating properties than the material forming each of the shield panels 210, 220, 230. Instead, in some embodiments the only direct connection between the central shield panel 210 and the left shield panel 220 can be the first joint 225, or can be a first upper joint 225 and a first lower joint, as described with reference to FIGS. 5 and 6. While in some embodiments this may be more expensive (by requiring relatively larger panels) and/or require different (e.g., more complex) manufacturing/assembly techniques than simply connecting the panels via a vertical hinge, the overlapping panels are expected to provide a more complete radiation shadow/radiation blocking footprint than structures with such vertical members, which may allow some radiation to pass therethrough.

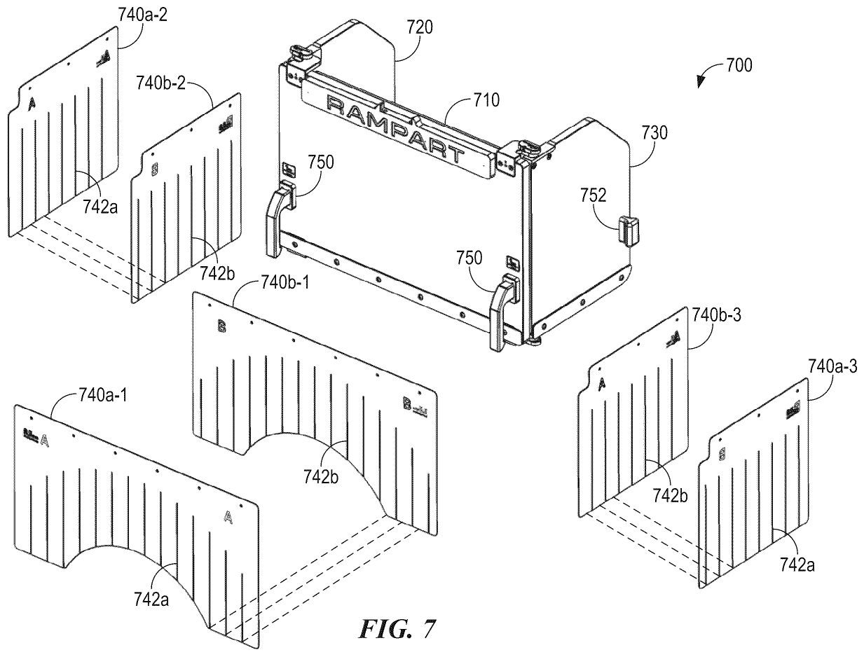

FIG. 7 is a partially exploded, perspective view of another radiation attenuating shield structure 700 configured in accordance with embodiments of the present technology. The radiation attenuating shield structure 700 can be generally similar to the radiation attenuating shield structure 200 of FIG. 1. For example, the radiation attenuating shield structure 700 can include a central shield panel 710, a left shield panel 720 rotatably coupled to the central shield panel 710, and a right shield panel 730 rotatably coupled to the central shield panel 710. The central shield panel 710 can include a pair of handles 750 attached to a front side thereof, and each of the left shield panel 720 and the right shield panel 730 can include a smaller handle 752 attached to a front side thereof. Unlike the rectangular-shaped left shield panel 220 and right shield panel 230 of FIG. 1, however, the left shield panel 720 and right shield panel 730 of FIG. 7 are pentagon-shaped with a diagonally-cut corner. In other embodiments, the central shield panel 710, the left shield panel 720, and/or the right shield panel 730 can have other shapes and sizes.

The radiation attenuating shield structure 700 can also include multiple pairs of flexible shields or curtains. Specifically, a first pair of flexible shields 740a-1, 740b-1 can both be coupled to a bottom edge of the central shield panel 710, a second pair of flexible shields 740a-2, 740b-2 can both be coupled to a bottom edge of the left shield panel 720, and a third pair of flexible shields 740a-3, 740b-3 can both be coupled to a bottom edge of the right shield panel 730 (collectively referred to as “the flexible shields 740”). The pairs of flexible shields (e.g., the flexible shields 740a-1, 740b-1) can have corresponding shapes and sizes such that the each shield within a pair substantially overlaps with one another.

The flexible shields 740 can include slits to enable the flexible shields 740 to more easily conform to various contours and to allow a user to access a patient by reaching “through” the flexible shields 740. For example, the flexible shield 740a-1 can have multiple first slits 742a and the flexible shield 740b-1 can have multiple second slits 742b. As discussed above with reference to the slits 242 of FIG. 1, the first and second slits 742a, 742b can divide the flexible shields 740a-1, 740b-1, respectively, into multiple strips. Notably, the first slits 742a are offset from the second slits 742b such that when the radiation attenuating shield structure 700 is assembled and the flexible shields 740a-1, 740b-1 overlap with one another, the first slits 742a do not align with the second slits 742b. Rather, the first slits 742a can be positioned in between adjacent second slits 742b, as indicated by the dashed lines in FIG. 7. Therefore, any radiation leaking through the second slits 742b is expected to be blocked by the strips of the flexible shield 740a-1 instead of also leaking through the first slits 742a, thus providing a more complete radiation shadow. Thus, providing the flexible shields 740 in pairs having offset slits is expected to improve the radiopacity of the flexible shields 740 without sacrificing the ability for the shielding to conform to various contours and for a user to reach through the flexible shielding (e.g., to access the patient). The flexible shields 740a-2, 740b-2 and the flexible shields 740a-3, 740b-3 can also have offset, non-overlapping slits 742a, 742b, as also indicated by the dashed lines in FIG. 7.

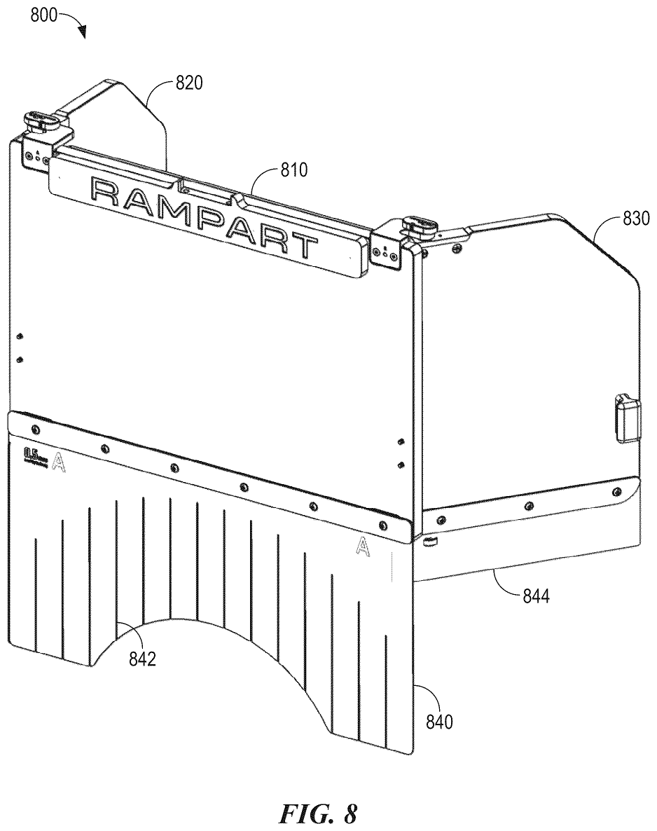

FIG. 8 is a perspective view of another radiation attenuating shield structure 800 configured in accordance with embodiments of the present technology. The radiation attenuating shield structure 800 can be generally similar to the radiation attenuating shield structure 200 of FIG. 1. For example, the radiation attenuating shield structure 800 can include a central shield 810, a left shield 820 rotatably coupled to the central shield 810, and a right shield 830 rotatably coupled to the central shield 810. The radiation attenuating shield structure 800 can also include a central flexible shield 840 attached to a bottom edge of the central shield 810, a left flexible shield (obscured from view) attached to the bottom edge of the left shield 820, and a right flexible shield 844 attached to the bottom edge of the right shield 830.

The central flexible shield 840 can be substantially similar to the corresponding flexible shield 240 of FIG. 1, and can include multiple slits 842. The right flexible shield 844 can have a different shape and size compared to the corresponding flexible shield 240 of FIG. 1. For example, in the illustrated embodiment, the right flexible shield 844 is shorter than the first central shield 840, has a rectangular form factor, and does not include slits. Including a shorter flexible shield can facilitate electrophysiology or other procedures. It is appreciated that that the central flexible shield 840, the left flexible shield (obscured from view), and/or the right flexible shield 844 can have different shapes and/or sizes for facilitating different procedures.

FIG. 9 is a perspective view of another radiation attenuating shield apparatus 900 (“the apparatus 900”) configured in accordance with various embodiments of the present technology. The apparatus 900 can include a movable cart 910, a support arm 950, and a radiation attenuating shield structure 990. The support arm 950 and the radiation attenuating shield structure 990 can be generally similar to the support arm 150 and the radiation attenuating shield structure 200, respectively, of FIG. 1, and so the description of the support arm 150 and the radiation attenuating shield structure 200 applies equally to the support arm 950 and the radiation attenuating shield structure 990.

The movable cart 910 can include a base 912, wheels 914 attached to the base 912, one or more trays 916, and one or more support structures (individually labeled 918a, 918b; collectively referred to as “the support structures 918”). Advantageously, the wheels 914 allow the movable cart 910 to be easily moved around, for example, an operating room. Thus, a user can adjust the position of the movable cart 910, and thus the position of the radiation attenuating shield structure 990, according to the specific needs of the operation. The trays 916 can support various medical or other equipment. The support structures 918 can each be coupled to a corresponding support arm 950. While FIG. 9 only illustrates the support structure 918a coupled to the support arm 950, in other embodiments, the support structure 918b can also be coupled to a support arm. In some embodiments, the support structures 918 can adjust the height of the support arm 950, and thus the height of the radiation attenuating shield structure 990.

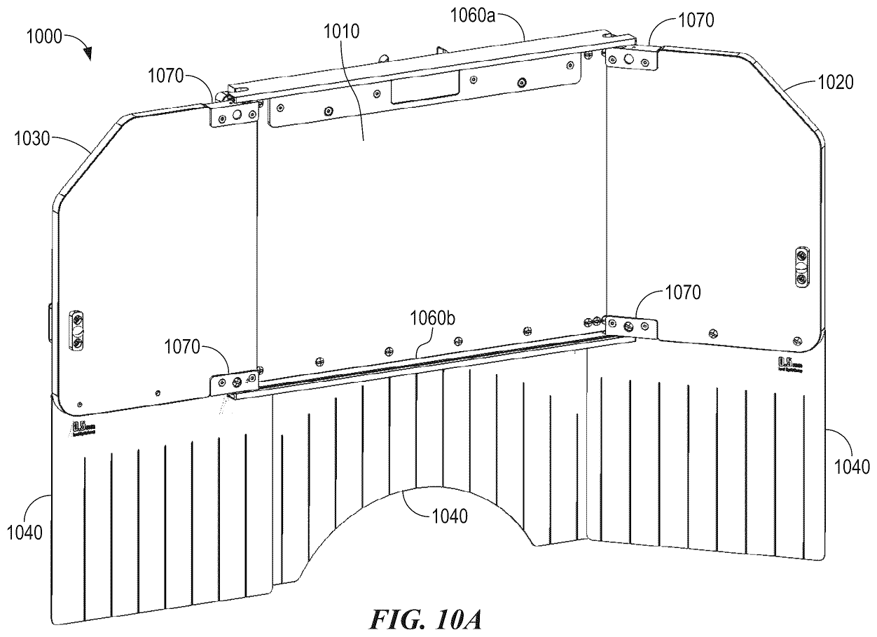

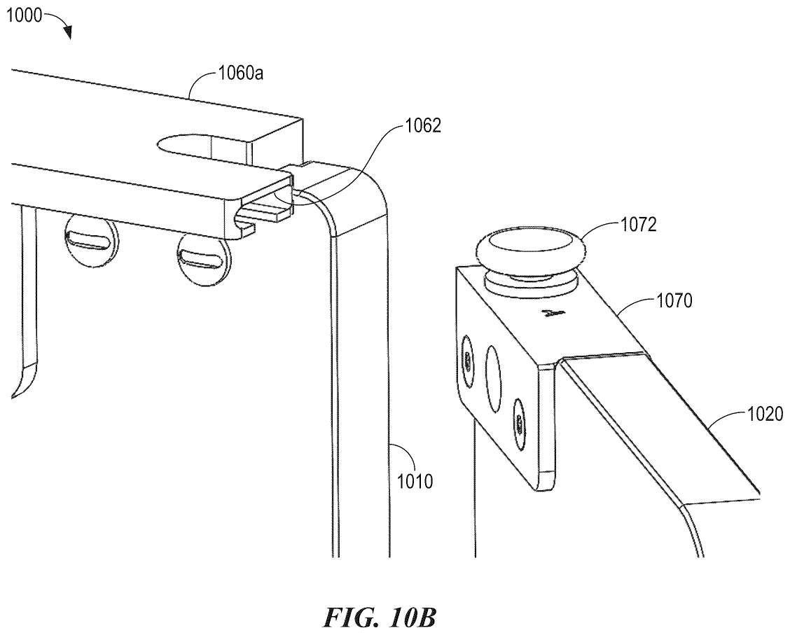

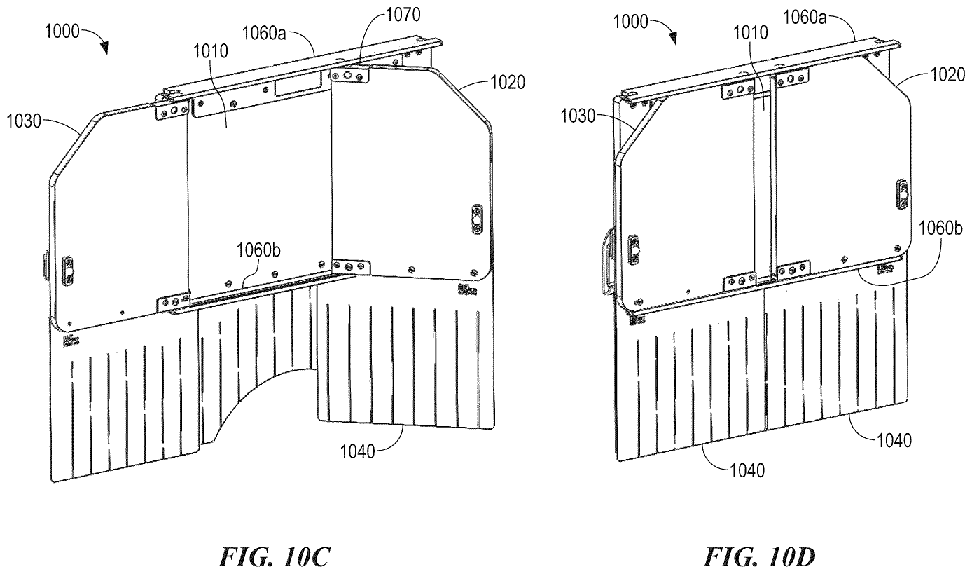

FIG. 10A is a rear perspective view of another radiation attenuating shield structure 1000 configured in accordance with various embodiments of the present technology. Certain aspects of the radiation attenuating shield structure 1000 can be generally similar to the radiation attenuating shield structure 200 of FIG. 1. For example, the radiation attenuating shield structure 1000 can include a first or central shield panel 1010, a second or left shield panel 1020 (on the right side of FIG. 10A, which is a rear view), and a third or right shield panel 1030 (on the left side of FIG. 10A). The radiation attenuating shield structure 1000 can also include one or more flexible shields or curtains 1040 each attached to a bottom edge of the central shield panel 1010, the left shield panel 1020, or the right shield panel 1030.

The radiation attenuating shield structure 1000 can further include a top lateral rail 1060a and a bottom lateral rail 1060b (collectively referred to as “the lateral rails 1060”) coupled to the top edge and the bottom edge, respectively, of the central shield panel 1010. Also, each of the left shield panel 1020 and the right shield panel 1030 can include one or more rail engagement brackets 1070. In the illustrated embodiment, the rail engagement brackets 1070 are attached to the two corners of each of the left shield panel 1020 and the right shield panel 1030 adjacent to the central shield panel 1010 (when the radiation attenuating shield structure 1000 is in the expanded configuration as shown). As discussed in greater detail below, the lateral rails 1060 and the rail engagement brackets 1070 enable the left shield panel 1020 and/or the right shield panel 1030 to both translate or slide laterally and rotate with respect to the central shield panel 1010.

FIG. 10B is an enlarged, partially exploded view of the radiation attenuating shield structure 1000. Specifically, FIG. 10B illustrates a portion of the top lateral rail 1060a attached to the central shield panel 1010 and, separately, the rail engagement bracket 1070 attached to the top corner of the left shield panel 1020. As shown, the top lateral rail 1060a can include a channel 1062 extending therethrough and the rail engagement bracket 1070 can include a disc-shaped knob 1072 protruding upward. The channel 1062 can be shaped and sized to receive the knob 1072. While not illustrated in FIG. 10B, the bottom lateral rail 1060b can have a similar channel and the other rail engagement brackets 1070 can each have a similar knob.

Accordingly, the radiation attenuating shield structure 1000 can be assembled by inserting the knobs 1072 into the channels 1062 of the respective lateral rails 1060, thereby coupling the left shield panel 1020 and the right shield panel 1030 to the central shield panel 1010. Also, each of the lateral rails 1060 can extend substantially along the width of the central shield panel 1010 (as best shown in FIG. 10A). Therefore, each of the knobs 1072 can move laterally within the channel 1062 such that the left shield panel 1020 and the right shield panel 1030 can slide along the lateral rails to translate relative to the central shield panel 1010. Also, because the knob 1072 is substantially disc-shaped, the knob 1072 can also rotate within the channel 1062, allowing the left shield panel 1020 and the right shield panel 1030 to also rotate with respect to the central shield panel 1010. In some embodiments, the knob 1072 and the channel 1062 are sized to reduce the likelihood that the left shield panel 1020 and the right shield panel 1030 move without user input, such as via sufficient interference fit.

FIGS. 10C and 10D are rear perspective views of the radiation attenuating shield structure 1000 in various configurations. Referring first to FIG. 10C, compared to the configuration illustrated in FIG. 10A, the left shield panel 1020 has moved along the lateral rails 1060 toward the center of the central shield panel 1010. Also, like in FIG. 10A, the left shield panel 1020 in FIG. 10C is oriented at an angle relative to the central shield panel 1010. Accordingly, FIG. 10C illustrates how the left shield panel 1020 can both translate and rotate relative to the central shield panel 1010. The flexible shield 1040 attached to the bottom edge of the left shield panel 1020 can translate and rotate with the left shield panel 1020. While the right shield panel 1030 is illustrated as not having moved along the lateral rails 1060, it is appreciated that the right shield panel 1030 can also translate and/or rotate relative to the central shield panel 1010, independently of the left shield panel 1020.

Referring next to FIG. 10D, both the left shield panel 1020 and the right shield panel 1030 have translated along the lateral rails 1060 toward the center of the central shield panel 1010 into a collapsed configuration. Each of the left shield panel 1020 and the right shield panel 1030 can have a width that is about half of the width of the central shield panel 1010. Therefore, as shown, both the left shield panel 1020 and the right shield panel 1030 can substantially overlap with the central shield panel 1010, as described above with reference to the radiation attenuating shield structure 200 of FIGS. 1-6. Also, the flexible shields 1040 attached to the bottom edges of the left shield panel 1020 and the right shield panel 1030, which move therewith, can substantially overlap with the flexible shield 1040 attached to the bottom edge of the central shield panel 1010 because the central shield panel 1010 is in a different plane than the left shield panel 1020 and the right shield panel 1030. As described above, the collapsed configuration is useful because it can minimize the device footprint when not in use, facilitate storage, make it easier to transport, amongst other advantages.

One skilled in the art will appreciate that the radiation attenuating shield structure 1000 of FIGS. 10A-10D is merely an illustrative example, and that other embodiments of the present technology can include fewer, additional, and/or alternative components, and/or combine features of the structure 1000 with other radiation attenuating shield structures described herein. For example, while the radiation attenuating shield structure 1000 is illustrated as allowing both translation and rotation of the left shield panel 1020 and the right shield panel 1030 relative to the central shield panel 1010, in other embodiments, the left shield panel 1020 and the right shield panel 1030 may only be able to translate relative to the central shield panel 1010 (e.g., the knob 1072 may have a rectangular form factor that prevents it from rotating within the channel 1062). As another example, while the radiation attenuating shield structure 1000 is illustrated as including the pair of lateral rails 1060, each extending along substantially the entire width of the central shield panel 1010, in other embodiments, the radiation attenuating shield structure 1000 can include a total of four lateral rails: two on the top and two on the bottom, each extending substantially half of the width of the central shield panel 1010 and dedicated to a corresponding one of the rail engagement brackets 1070.

### Representative Operative Set-ups Using Radiation Attenuating Shield Apparatuses

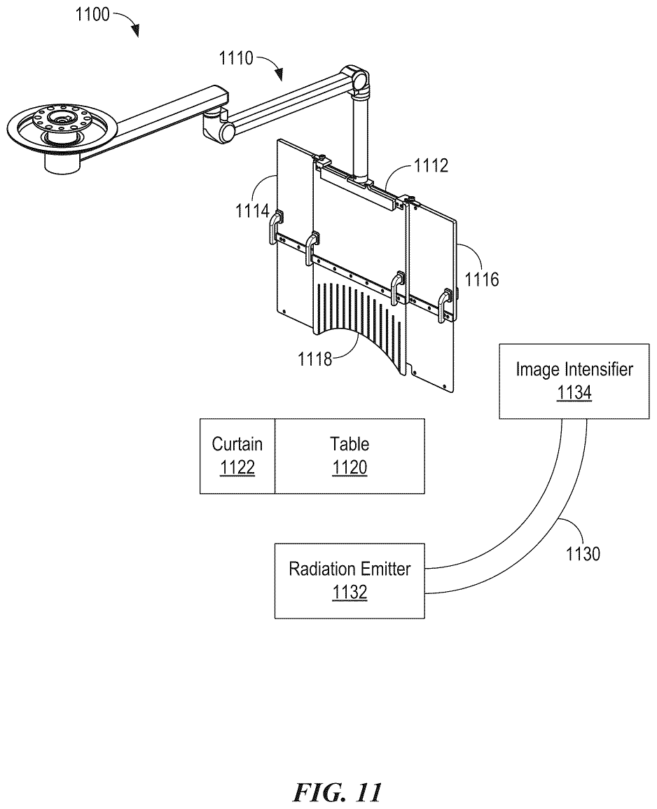

The radiation attenuating shield apparatuses of the present technology may be part of a greater medical imaging system. To illustrate, FIG. 11 is a partially schematic view of a medical imaging system 1100 (“the system 1100”) comprising a radiation attenuating shield apparatus 1110 (“the apparatus 1110”), a table 1120, a radiation emitter 1132, and an image intensifier 1134. The radiation emitter 1132 can be positioned to direct x-rays and/or other imaging rays through the table 1120 and to the image intensifier 1134 on the other side, as is known in the art. The radiation emitter 1132 and the image intensifier 1134 can be mutually mounted on a C-arm 1130, for example. The table 1120 can have a radiation attenuating curtain 1122 hanging from at least one side of the table 1120. The curtain 1122 may also extend around two or more sides of the table 1120. The curtain 1122 can be particularly useful when the radiation emitter 1132 is positioned below the table 1120.

The subject (not shown) can generally lying on the table 1120 in any suitable orientation, including supine, prone, and lying on the side. In one configuration, the subject can be positioned on the table 1120 and between the radiation emitter 1132 and the image intensifier 1134. In other configurations, however, the table 1120, the radiation emitter 1132, the image intensifier 1134, and the subject can be in different arrangements. The table 1120 can be capable of supporting the subject. Depending on the age and size of the subject, various configurations of table 1120 could be used. The image intensifier 1134 can be positioned to receive X-rays projected from the radiation emitter 1132 (such as being positioned above the table 1120 if the radiation emitter 1132 is positioned below the table 1120).

In various embodiments of the system 1100, the apparatus 1110 can assume various configurations relative to the table 1120 and the radiation emitter 1132. In some embodiments, for example, the apparatus 1110 can be configured so that the central shield panel 1112, the left shield panel 1114, and right shield panel 1116 are approximately parallel to a longitudinal axis of the table 1120, and positioned at a height just above that of the table 1120 to prevent radiation from shining between the table 1120 and the shield panels 1112, 1114, 1116. In some embodiments, the one or more flexible shields 1118 cover the gap between (i) the bottom edge of any or all of the central shield panel 1112, the left shield panel 1114, and the right shield panel 1116 and (ii) the height of the table 1120. In further embodiments, the shield panels 1112, 1114, 1116 can be positioned such that the one or more flexible shields 1118 contact the table 1120 and/or the subject. When approximately parallel to the longitudinal axis of the table 1120, the shield panels 1112, 1114, 1116 may form a long barrier alongside the subject, creating a large shadow on one side of the table 1120. Alternatively, the shield panels 1112, 1114, 1116 could be arranged to extend substantially parallel to the longitudinal axis of the table 1120 and be placed over the subject, bisecting the patient and casting a shadow on the left or right side of the shield panels 1112, 1114, 1116 (in such situations, the radiation emitter 1132 can be positioned to the left or to the right of the shield panels 1112, 1114, 1116).

It is appreciated that the apparatus 1110 can be positioned in various different ways to create radiation shadows to serve different purposes. For example, in some embodiments, the apparatus 1110 can be configured such that the central shield panel 1112 is positioned to be parallel or generally parallel to a transverse axis of the table 1120. In some embodiments, the shield panels 1112, 1114, 1116 can be positioned to create a radiation shadow to the right of the subject, to the left of the subject, and on one of the superior or inferior sides of the subject simultaneously. In such configurations, the shield panels 1112, 1114, 1116 could be rotated or “folded” to form a trapezoid or a rectangle in which the central shield panel 1112 is positioned transversely across the subject. If the radiation emitter 1132 is superior to the central shield panel 1112, the radiation shadow will be on the inferior side of central shield panel 1112; if the radiation emitter 1132 is inferior to the central shield panel 1112, the radiation shadow will be on the superior side of central shield panel 1112.

In some embodiments, the shield panels 1112, 1114, 1116 may be positioned to create a radiation shadow on the right or left side of the subject. Such configurations may include the generally straight line configurations described above. For example, the central shield panel 1112, the right shield panel 1116, and the left shield panel 1114 may be positioned in a straight line along the midline of the subject, or along a line parallel to the midline. The shield panels 1112, 1114, 1116 could be positioned to contact the subject along the midline or a line parallel to the midline while the flexible shields 1118 are connected to the bottom edges of the shields. As one skilled in the art will appreciate, the apparatus 1110 can be the same as or generally similar to any of the radiation attenuating apparatuses described herein, such as the radiation attenuating apparatus 100 (FIGS. 1-6), 700 (FIGS. 7), 800 (FIGS. 8), 900 (FIG. 9), or 1000 (FIG. 10).

### Representative Methods of Using Radiation Attenuating Shield Apparatuses

Continuing to refer to FIG. 11, a method of radiology is provided, using any embodiment of the radiation shield apparatus disclosed above. The method comprises positioning any or all of the central shield panel 1112, the left shield panel 1114, and the right shield panel 1116 between the user and the radiation emitter 1132 such that the user is in a radiation shadow cast by the shield panels 1112, 1114, 1116. Such positioning may place any or all of the central shield panel 1112, the left shield panel 1114, and the right shield panel 1116 between the user and the subject. The method may further involve irradiating the subject using the radiation emitter 1132 positioned such that radiation passes at least partially through the subject. A surgical device, such as an endoscopic device, may be inserted into the patient during the procedure, such as at a part of the subject irradiated by the radiation emitter 1132. Thus, advantageously, the user can monitor and otherwise handle the surgical device throughout the procedure while reducing the user's exposure to radiation.

Some embodiments of the apparatus 1110 and the system 1100 described herein are suitable for a method of protecting a user from radiation emitted by the radiation emitter 1132 below the table 1120 during a medical procedure, wherein a subject's body is resting on the table 1120. The one or more flexible shields 1118, connected to the shield panels 1112, 1114, 1116, can help create a more complete radiation shield and further protect the user.

In some embodiments, the central shield panel 1112 can be positioned transversely across the subject's body so that the one or more flexible shields 1118 contact the patient, the left shield panel 1114 is to the left of the subject's body, and the right shield panel 1116 is to the right of the subject's body, such that the central shield panel 1112 defines a superior side and an inferior side of the subject's body. Positioning either the left shield panel 1114 or the right shield panel 1116 (collectively referred to as “the side shield panels” herein) at an angle of at least 45° relative to the central shield panel 1112 can define a lateral side and a medial side of the subject. The radiation emitter 1132 is then oriented to emit radiation through either the superior or inferior side of the subject defined by the central shield panel 1112. As a result, the apparatus 1110 creates a radiation shadow on either the superior or inferior side of the central shield panel 1112, and on the lateral side of the side shield panels 1114, 1116. In further embodiments of the method, the left shield panel 1114 or the right shield panel 1116 can be positioned at about 90° relative to the central shield panel 1112. In further embodiments of the method, both side shield panels 1114, 1116 are positioned at at least 45° relative to the central shield panel 1112.

Another approach comprises positioning the central shield panel 1112 sagittally across the subject's body such that the one or more flexible shields 1118 contact the subject and the central shield panel 1112 defines a right side and a left side of the subject's body. One or both of the side shield panels 1114, 1116 may then be positioned at an angle of less than 45° relative to the central shield panel 1112, such that the side shield panels 1114, 1116 define a left side and a right side of the subject. The radiation emitter 1132 can be oriented to emit radiation through the subject either to the right or the left of the central shield panel 1112; and the shield panels can create a radiation shadow on either the right of left side of the central shield panel 1112 and one or both of the side shield panels 1114, 1116. In some embodiments of the method, one or both of the side shield panels 1114, 1116 are positioned at an angle of about 0°, less than 45°, about 45°, greater than 45°, or other angle relative to the central shield panel 1112.

### EXAMPLES

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.
1. A radiation attenuating shield apparatus, comprising:
a first panel configured to at least partially block transmission of radiation, wherein the first panel includes a first side edge region; and
a second panel configured to at least partially block transmission of radiation, wherein the second panel includes a second side edge region, and wherein the second panel is movably coupled to the first panel,
wherein the radiation attenuating shield apparatus is configurable between (i) a collapsed configuration in which at least 80% of the second panel overlaps with the first panel to define a first radiation blocking footprint, and (ii) an expanded configuration in which less than 20% of the second panel overlaps with the first panel to define a second radiation blocking footprint that is greater than the first radiation blocking footprint, and
wherein, in the expanded configuration, the first side edge region of the first panel at least partially overlaps with the second side edge region of the second panel.
2. The radiation attenuating shield apparatus of example 1, wherein, in the expanded configuration, the first side edge region and the second side edge region have an overlapping region of between about 2 cm and about 10 cm.
3. The radiation attenuating shield apparatus of example 1 or example 2, wherein the radiation attenuating shield apparatus does not include an elongate vertical member directly coupling the first side edge region and the second side edge region.
4. The radiation attenuating shield apparatus of any of examples 1-3, wherein the second panel is rotatably coupled to the first panel, and wherein the radiation attenuating shield apparatus is configurable between the collapsed configuration and the expanded configuration by rotating the second panel about a vertical axis.
5. The radiation attenuating shield apparatus of example 4, wherein the second panel is rotatably coupled to the first panel via (a) an upper joint positioned proximate an upper portion of the first panel and an upper portion of the second panel, and (b) a lower joint positioned proximate a lower portion of the first panel and a lower portion of the second panel.
6. The radiation attenuating shield apparatus of any of examples 1-3, wherein the second panel is slidably coupled to the first panel, and wherein the radiation attenuating shield apparatus is configurable between the collapsed configuration and the expanded configuration by sliding the second panel relative to the first panel.
7. The radiation attenuating shield apparatus of example 6, wherein the second panel is slidably coupled to the first panel via (a) a rail defining a channel extending along at least one of a top edge or a bottom edge of the first panel, and (b) a knob attached to a top edge or a bottom edge of the second panel, wherein the knob is sized and shaped to be slidably received within the channel.
8. The radiation attenuating shield apparatus of any of examples 1-7, further comprising a third panel movably coupled to the first panel and configured to at least partially block transmission of radiation, wherein:
when the radiation attenuating shield apparatus is in the collapsed configuration, at least 80% of the third panel overlaps with the first panel, and
when the radiation attenuating shield apparatus is in the expanded configuration, less than 20% of the third panel overlaps with the first panel.
9. The radiation attenuating shield apparatus of example 8, wherein:
the second panel is rotatably coupled to the first side edge region of the first panel, and
the third panel is rotatably coupled to a third side edge region of the first panel that is on an opposite end of the first panel from the first side edge region.
10. The radiation attenuating shield apparatus of example 8, wherein:
the second panel is slidably coupled to the first panel,
the third panel is slidably coupled to the first panel, and
in the expanded configuration, the second panel and the third panel extend from the first panel in opposite directions.
11. The radiation attenuating shield apparatus of any of examples 8-10, wherein the first panel has a first width, the second panel has a second width, and the third panel has a third width, and wherein each of the second width and the third width is about half of the first width.
12. The radiation attenuating shield apparatus of any of examples 1-11, further comprising:
a first flexible curtain configured to at least partially block the transmission of radiation, wherein the first flexible curtain is coupled to a bottom edge of the first panel and includes a first plurality of slits dividing the first flexible curtain into a first plurality of flexible strips; and
a second flexible curtain configured to at least partially block the transmission of radiation, wherein the second flexible curtain is coupled to the bottom edge of the first panel and overlaps with the first flexible curtain, wherein the second flexible curtain includes a second plurality of slits dividing the second flexible curtain into a second plurality of flexible strips,
wherein the first plurality of slits and the second plurality of slits are offset from one another.
13. The radiation attenuating shield apparatus of any of examples 1-11, further comprising:
a first flexible curtain configured to at least partially block the transmission of radiation, wherein the first flexible curtain is coupled to a bottom edge of the first panel and has a first length; and
a second flexible curtain configured to at least partially block the transmission of radiation, wherein the second flexible curtain is coupled to a bottom edge of the second panel and has a second length that is shorter than the first length.
14. The radiation attenuating shield apparatus of any of examples 1-13, further comprising an articulating arm for supporting the first panel and the second panel, wherein the articulating arm is coupled to the first panel via a bracket extending along a top edge of the first panel.
15. The radiation attenuating shield apparatus of example 14, wherein the articulating arm is ceiling-mounted.
16. The radiation attenuating shield apparatus of example 14, wherein the articulating arm is supported by a moveable cart.
17. A radiation attenuating shield apparatus, comprising:
a first panel configured to at least partially block transmission of radiation;
a second panel configured to at least partially block transmission of radiation; and
a joint rotatably coupling the second panel to the first panel such that the second panel can rotate along an arc of at least 180 degrees between a collapsed configuration and an expanded configuration,
wherein the second panel overlaps with the first panel by at least 2 cm in the expanded configuration.
18. The radiation attenuating shield apparatus of example 17, wherein the first panel is rotatable relative to the second panel along an arc of at least 210 degrees.
19. The radiation attenuating shield apparatus of example 17 or example 18, wherein the first panel includes a first top edge, the second panel includes a second top edge, and the joint rotatably couples the second top edge to the first top edge.
20. The radiation attenuating shield apparatus of example 19, wherein the joint is a first joint, and wherein the radiation attenuating shield apparatus includes a second joint rotatably coupling the second panel to the first panel.
21. The radiation attenuating shield apparatus of example 20, wherein the first panel includes a first bottom edge, the second panel includes a second bottom edge, and wherein the second joint rotatably couples the second bottom edge to the first bottom edge.
22. The radiation attenuating shield apparatus of example 21, wherein the first panel is not directly coupled to the second panel other than at the first joint and the second joint.
23. The radiation attenuating shield apparatus of any of examples 17-22, wherein the first panel and the second panel define a first radiation blocking footprint in the collapsed configuration and a second radiation blocking footprint in the expanded configuration, and wherein the second radiation blocking footprint is larger than the first radiation blocking footprint.
24. A radiation attenuating shield apparatus, comprising:
a first panel configured to at least partially block transmission of radiation, wherein the first panel extends along a first plane; and
a second panel configured to at least partially block transmission of radiation movably coupled to the first panel,
wherein the radiation attenuating shield apparatus is configurable between (i) a collapsed configuration in which the second panel substantially overlaps with the first panel, and (ii) an expanded configuration in which the panel extends outward from the first panel along a second plane parallel to the first plane, and,
wherein the radiation attenuating shield apparatus does not include a vertical member positioned between the first panel and the second panel.
25. The radiation attenuating shield apparatus of example 24 wherein the first plane and the second plane are different.
26. The radiation attenuating shield apparatus of example 24 or example 25, wherein, when the radiation attenuating shield apparatus is in the expanded configuration, the second panel partially overlaps the first panel.
27. The radiation attenuating shield apparatus of any of examples 24-26, wherein the second panel is rotatably coupled to the first panel via a joint coupled to a top edge of each of the first panel and the second panel.
28. The radiation attenuating shield apparatus of any of examples 24-26, wherein the second panel is slidably coupled to the first panel, and wherein the radiation attenuating shield apparatus is configurable between the collapsed configuration and the expanded configuration by sliding the second panel along the second plane.
29. The radiation attenuating shield apparatus of any of examples 24-28, further comprising a third panel configured to at least partially block transmission of radiation, wherein:
in the collapsed configuration, the third panel substantially overlaps with the first panel, and
in the expanded configuration, the third panel extends outward from the first panel along the second plane and in an opposite direction relative to the second panel.
30. The radiation attenuating shield apparatus of example 29 wherein a combined width of the second panel and the third panel is about the same as a width of the first panel.
31. A radiation attenuating shield apparatus configured to be used above a table for supporting a patient, the apparatus comprising:
(a) a radiation attenuating shield structure, comprising:
   (i) a central shield that is radiation attenuating, having a first width, and having a bottom edge;
   (ii) a left shield that is radiation attenuating connected to the central shield and configured to rotate relative to the central shield along a first approximately vertical axis, and having a second width about equal to half the first width and having a bottom edge;
   (iii) a right shield that is radiation attenuating connected to the central shield and configured to rotate relative to the central shield along a second approximately vertical axis, and having a third width about equal to half the first width and having a bottom edge;
   wherein one or more flexible shields may be connected to the bottom edges of the central shield, the left shield, and the right shield; and
(b) a support arm connected to the central shield; wherein the support arm is configured to support the radiation attenuating shield structure; and wherein the support arm is configured to translate and rotate the radiation attenuating shield structure relative to the table.
32. The radiation attenuating shield apparatus of example 31, wherein the bottom edges of the central shield, the left shield and the right shield are approximately flush with one another.
33. The radiation attenuating shield apparatus of example 31 or example 32, wherein the apparatus is configured to allow the central shield to rotate relative to the support arm.
34. The radiation attenuating shield apparatus of example 33, wherein the apparatus is configured to allow the central shield to rotate relative to the support arm about a third approximately vertical axis.
35. The radiation attenuating shield apparatus of example 33, wherein the apparatus is configured to allow the shield structure to rotate relative to the support arm as a unit.
36. The radiation attenuating shield apparatus of any of examples 31-35, wherein the left shield is connected to the central shield via a left radiation attenuating joint and the right shield is connected to the central shield via a right radiation attenuating joint.
37. The radiation attenuating shield apparatus of example 36, wherein the left shield is supported by the left radiation attenuating joint; and the right shield is supported by the right radiation attenuating joint.
38. The radiation attenuating shield apparatus of any of examples 31-37, wherein a sum of the first width, second width, and third width is about 58 inches (147 cm).
39. The radiation attenuating shield apparatus of any of examples 37-38, wherein the left shield is configured to rotate in at least a 180° arc about the first approximately vertical axis.
40. The radiation attenuating shield apparatus of any of examples 31-39, wherein the right shield is configured to rotate in at least a 180° arc about the second approximately vertical axis.
41. The radiation attenuating shield apparatus of any of examples 21-30, wherein the central shield is generally rectangular, the right shield is generally rectangular, and the left shield is generally rectangular.
42. The radiation attenuating shield apparatus of any of examples 31-41, wherein the central shield is generally square.
43. The radiation attenuating shield apparatus of any of examples 31-42, wherein the central shield, the right shield, and the left shield form a radiation attenuating barrier.
44. The radiation attenuating shield apparatus of any of examples 31-43, wherein the radiation attenuating shield apparatus is configured to translate as a unit independent of the table.
45. The radiation attenuating shield apparatus of any of examples 31-44, wherein the support arm is an overhead arm.
46. The radiation attenuating shield apparatus of any of examples 31-45, wherein the support arm is supported by a ceiling-mount or a wall-mount.
47. The radiation attenuating shield apparatus of any of examples 31-46, connected to a floor-stand that supports the radiation attenuating shield apparatus.
48. The radiation attenuating shield apparatus of any of examples 31-47, connected to a floor-stand that supports the radiation attenuating shield apparatus; wherein the floor-stand is configured to translate the radiation attenuating shield apparatus relative to the table.
49. The radiation attenuating shield apparatus of any of examples 31-48, wherein the central shield, right shield, and left shield may be configured to block radiation from reaching users to the right of the patient, to the left of the patient, and on one of the superior or inferior side of the patient simultaneously.
50. The radiation attenuating shield apparatus of any of examples 31-49, wherein the central shield, right shield, and left shield may be positioned as the base and the stems of a trapezoid.
51. The radiation attenuating shield apparatus of example 50, wherein the central shield, right shield, and left shield may be positioned as the base and stems of a trapezoid such that the base of the trapezoid is positioned transversely across a subject's body, a first stem of the trapezoid is positioned is to the right of the subject's body, and a second stem of the trapezoid is to the left of the subject's body.
52. The radiation attenuating shield apparatus of any of examples 31-51, wherein the central shield, right shield, and left shield may be positioned in a straight line.
53. The radiation attenuating shield apparatus of example 52, wherein the central shield, right shield, and left shield may be positioned in a straight line along a midline of a subject, and wherein the radiation attenuating shield structure contacts the subject along the midline when the one or more flexible shields are be connected to the bottom edges of the central shield, left shield, and right shield.
54. The radiation attenuating shield apparatus of any of examples 31-53, wherein the left shield is configured to rotate relative to the central shield along the first approximately vertical axis when the radiation attenuating shield apparatus is in use.
55. The radiation attenuating shield apparatus of any of examples 31-54, wherein the right shield is configured to rotate relative to the central shield along the first approximately vertical axis when the radiation attenuating shield apparatus is in use.
56. The radiation attenuating shield apparatus of any of examples 31-55, wherein: when the central shield is positioned transversely across the patient, the central shield, the right shield, and the left shield can be oriented relative to one another to create a radiation shadow on either the superior or inferior side of the central shield, and on the lateral side of right shield, the left shield, or both the right shield and the left shield.
57. The radiation attenuating shield apparatus of any of examples 31-56, wherein: when the central shield is positioned parallel to the patient, the central shield, the right shield, and the left shield can be oriented relative to one another to create a radiation shadow on either the right or the left side of the central shield.
58. The radiation attenuating shield apparatus of any of examples 31-57, wherein: when the central shield is positioned sagittally over the patient, a side shield may be positioned at an angle of less than 45° to the central shield, wherein the side shield is the left shield or the right shield, the shield structure creates a radiation shadow on either the right of left side of the central shield and the side shield.
59. The radiation attenuating shield apparatus of any of examples 31-58, wherein the apparatus is configured to position the radiation attenuating shield structure above a subject when the subject is on the table.
60. The radiation attenuating shield apparatus of any of examples 31-59, wherein the apparatus is configured to position the radiation attenuating shield structure entirely above the height of the table.
61. A system for shielding a user while said user attends to a subject, the system comprising:
(a) a table constructed to support the subject, the table having a longitudinal axis and a transverse axis;
(b) a radiation emitter positioned below the table;
(c) an image intensifier positioned above the table to receive X-rays projected from the radiation emitter;
(d) a radiation attenuating curtain extending downwardly from the table on at least a first side of the table; and
(e) the radiation attenuating shield apparatus of example 31, adapted to allow the central shield to be positioned above the table parallel to the longitudinal axis or parallel to the transverse axis.
62. The system of example 61, wherein the central shield is adapted to rotate to any angle relative to the longitudinal axis.
63. A method of protecting a user from radiation emitted from a radiation emitter below a table during a medical procedure, wherein a subject's body is located on the table, comprising: providing the apparatus of example 31; and positioning at least one of the central shield, the left shield, and the right shield between the radiation emitter and the user.
64. A method of protecting a user from radiation emitted from a radiation emitter below a table during a medical procedure, wherein a subject's body is located on the table, the method comprising:
(a) providing the apparatus of example 31, and further comprising a flexible shield connected to a bottom edge of the central shield;
(b) positioning the central shield transversely across the subject's body so that the flexible shield contacts the patient, the left shield is to the left of the subject's body, and the right shield is to the right of the subject's body, such that the central shield defines a superior side and an inferior side; and
(c) positioning a side shield at an angle of at least 45° to the central shield, such that the side shield defines a lateral side and a medial side, wherein the side shield is the left shield or the right shield;
wherein:
   the radiation emitter is oriented to emit radiation through the patient either superior or inferior to the central shield; and
   the shield structure creates a radiation shadow on either the superior or inferior side of the central shield, and on the lateral side of the side shield.
65. The method of example 64, wherein the side shield is positioned at about 90° to the central shield.
66. The method of example 64 or example 65, wherein the right shield is positioned at an angle of at least 45° to the central shield and the left shield is positioned at an angle of at least 45° to the central shield.
67. The method of any of examples 64-66, wherein the central shield, right shield, and left shield are positioned relative to one another in a trapezoidal shape.
68. A method of protecting a user from radiation emitted from a radiation emitter below a table during a medical procedure, wherein a subject's body is located on the table, the method comprising:
(a) providing the apparatus of example 31 comprising a flexible shield connected to a bottom edge of the central shield;
(b) positioning the central shield sagittally across the subject's body so that the flexible shield contacts the patient, such that the central shield defines a right side and a left side; and
(c) positioning a side shield at an angle of less than 45° to the central shield, such that the side shield defines a left side and a right side, wherein the side shield is the left shield or the right shield;
wherein: the radiation emitter is oriented to emit radiation through the patient either to the right or the left of the central shield; and the shield structure creates a radiation shadow on either the right of left side of the central shield and the side shield.
69. The method of example 68, wherein the side shield is positioned at about 0° to the central shield.
70. The method of example 68 or example 69, wherein the right shield is positioned at an angle of less than 45° to the central shield and the left shield is positioned at an angle of less than 45° to the central shield.
71. The method of any of examples 68-70, wherein the central shield, right shield, and left shield are positioned relative to one another in an approximately linear configuration.

### Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

As used herein, the use of relative terminology, such as “about”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art. Additionally, all ranges disclosed herein are to be understood to encompass the endpoints, and any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A radiation attenuating shield apparatus, comprising:
a first panel configured to at least partially block transmission of radiation, wherein the first panel includes a first side edge region; and
a second panel configured to at least partially block transmission of radiation, wherein the second panel includes a second side edge region, and wherein the second panel is movably coupled to the first panel,
wherein the radiation attenuating shield apparatus is configurable between (i) a collapsed configuration in which at least 80% of the second panel overlaps with the first panel to define a first radiation blocking footprint, and (ii) an expanded configuration in which less than 20% of the second panel overlaps with the first panel to define a second radiation blocking footprint that is greater than the first radiation blocking footprint, and
wherein, in the expanded configuration, the first side edge region of the first panel at least partially overlaps with the second side edge region of the second panel.

2. The radiation attenuating shield apparatus of claim 1, wherein, in the expanded configuration, the first side edge region and the second side edge region have an overlapping region of between about 2 cm and about 10 cm.

3. The radiation attenuating shield apparatus of claim 1, wherein the radiation attenuating shield apparatus does not include an elongate vertical member directly coupling the first side edge region and the second side edge region.

4. The radiation attenuating shield apparatus of claim 1, wherein the second panel is rotatably coupled to the first panel, and wherein the radiation attenuating shield apparatus is configurable between the collapsed configuration and the expanded configuration by rotating the second panel about a vertical axis.

5. The radiation attenuating shield apparatus of claim 4, wherein the second panel is rotatably coupled to the first panel via (a) an upper joint positioned proximate an upper portion of the first panel and an upper portion of the second panel, and (b) a lower joint positioned proximate a lower portion of the first panel and a lower portion of the second panel.

6. The radiation attenuating shield apparatus of claim 1, wherein the second panel is slidably coupled to the first panel, and wherein the radiation attenuating shield apparatus is configurable between the collapsed configuration and the expanded configuration by sliding the second panel relative to the first panel.

7. The radiation attenuating shield apparatus of claim 6, wherein the second panel is slidably coupled to the first panel via (a) a rail defining a channel extending along at least one of a top edge or a bottom edge of the first panel, and (b) a knob attached to a top edge or a bottom edge of the second panel, wherein the knob is sized and shaped to be slidably received within the channel.

8. The radiation attenuating shield apparatus of claim 1, further comprising a third panel movably coupled to the first panel and configured to at least partially block transmission of radiation, wherein:
when the radiation attenuating shield apparatus is in the collapsed configuration, at least 80% of the third panel overlaps with the first panel, and
when the radiation attenuating shield apparatus is in the expanded configuration, less than 20% of the third panel overlaps with the first panel.

9. The radiation attenuating shield apparatus of claim 8, wherein:
the second panel is rotatably coupled to the first side edge region of the first panel, and
the third panel is rotatably coupled to a third side edge region of the first panel that is on an opposite end of the first panel from the first side edge region.

10. The radiation attenuating shield apparatus of claim 8, wherein:
the second panel is slidably coupled to the first panel,
the third panel is slidably coupled to the first panel, and
in the expanded configuration, the second panel and the third panel extend from the first panel in opposite directions.

11. The radiation attenuating shield apparatus of claim 8, wherein the first panel has a first width, the second panel has a second width, and the third panel has a third width, and wherein each of the second width and the third width is about half of the first width.

12. The radiation attenuating shield apparatus of claim 1, further comprising:
a first flexible curtain configured to at least partially block the transmission of radiation, wherein the first flexible curtain is coupled to a bottom edge of the first panel and includes a first plurality of slits dividing the first flexible curtain into a first plurality of flexible strips; and
a second flexible curtain configured to at least partially block the transmission of radiation, wherein the second flexible curtain is coupled to the bottom edge of the first panel and overlaps with the first flexible curtain, wherein the second flexible curtain includes a second plurality of slits dividing the second flexible curtain into a second plurality of flexible strips,
wherein the first plurality of slits and the second plurality of slits are offset from one another.

13. The radiation attenuating shield apparatus of claim 1, further comprising:
a first flexible curtain configured to at least partially block the transmission of radiation, wherein the first flexible curtain is coupled to a bottom edge of the first panel and has a first length; and
a second flexible curtain configured to at least partially block the transmission of radiation, wherein the second flexible curtain is coupled to a bottom edge of the second panel and has a second length that is shorter than the first length.

14. The radiation attenuating shield apparatus of claim 1, further comprising an articulating arm for supporting the first panel and the second panel, wherein the articulating arm is coupled to the first panel via a bracket extending along a top edge of the first panel.

15. The radiation attenuating shield apparatus of claim 14, wherein the articulating arm is ceiling-mounted.

16. The radiation attenuating shield apparatus of claim 14, wherein the articulating arm is supported by a moveable cart.

17. A radiation attenuating shield apparatus, comprising:
a first panel configured to at least partially block transmission of radiation;
a second panel configured to at least partially block transmission of radiation; and
a joint rotatably coupling the second panel to the first panel such that the second panel can rotate along an arc of at least 180 degrees between a collapsed configuration and an expanded configuration,
wherein the second panel overlaps with the first panel by at least 2 cm in the expanded configuration.

18. The radiation attenuating shield apparatus of claim 17, wherein the first panel is rotatable relative to the second panel along an arc of at least 210 degrees.

19. The radiation attenuating shield apparatus of claim 17, wherein the first panel includes a first top edge, the second panel includes a second top edge, and the joint rotatably couples the second top edge to the first top edge.

20. The radiation attenuating shield apparatus of claim 19, wherein the joint is a first joint, and wherein the radiation attenuating shield apparatus includes a second joint rotatably coupling the second panel to the first panel.

21. The radiation attenuating shield apparatus of claim 20, wherein the first panel includes a first bottom edge, the second panel includes a second bottom edge, and wherein the second joint rotatably couples the second bottom edge to the first bottom edge.

22. The radiation attenuating shield apparatus of claim 21, wherein the first panel is not directly coupled to the second panel other than at the first joint and the second joint.

23. The radiation attenuating shield apparatus of claim 17, wherein the first panel and the second panel define a first radiation blocking footprint in the collapsed configuration and a second radiation blocking footprint in the expanded configuration, and wherein the second radiation blocking footprint is larger than the first radiation blocking footprint.

24. A radiation attenuating shield apparatus, comprising:
a first panel configured to at least partially block transmission of radiation, wherein the first panel extends along a first plane; and
a second panel configured to at least partially block transmission of radiation movably coupled to the first panel,
wherein the radiation attenuating shield apparatus is configurable between (i) a collapsed configuration in which the second panel substantially overlaps with the first panel, and (ii) an expanded configuration in which the panel extends outward from the first panel along a second plane parallel to the first plane, and,
wherein the radiation attenuating shield apparatus does not include a vertical member positioned between the first panel and the second panel.

25. The radiation attenuating shield apparatus of claim 24 wherein the first plane and the second plane are different.

26. The radiation attenuating shield apparatus of claim 24, wherein, when the radiation attenuating shield apparatus is in the expanded configuration, the second panel partially overlaps the first panel.

27. The radiation attenuating shield apparatus of claim 24, wherein the second panel is rotatably coupled to the first panel via a joint coupled to a top edge of each of the first panel and the second panel.

28. The radiation attenuating shield apparatus of claim 24, wherein the second panel is slidably coupled to the first panel, and wherein the radiation attenuating shield apparatus is configurable between the collapsed configuration and the expanded configuration by sliding the second panel along the second plane.

29. The radiation attenuating shield apparatus of claim 24, further comprising a third panel configured to at least partially block transmission of radiation, wherein:
in the collapsed configuration, the third panel substantially overlaps with the first panel, and
in the expanded configuration, the third panel extends outward from the first panel along the second plane and in an opposite direction relative to the second panel.

30. The radiation attenuating shield apparatus of claim 29 wherein a combined width of the second panel and the third panel is about the same as a width of the first panel.
